(19) United States
(12) Patent Application Publication
(10) Pub. No.: US 2026/0030185 A1
(43) Pub. Date: Jan. 29, 2026

(54) DELAYED MEMORY MANAGEMENT OPERATIONS

(71) Applicant: Micron Technology, Inc., Boise, ID (US)

(72) Inventor: David Aaron Palmer, Boise, ID (US)

(21) Appl. No.: 19/258,685

(22) Filed: Jul. 2, 2025

Related U.S. Application Data
(60) Provisional application No. 63/674,709, filed on Jul. 23, 2024.

(51) Int. Cl. G06F 13/16; G06F 12/02

(52) U.S. Cl. CPC G06F 13/1689; G06F 12/0246; G06F 13/1673

(57) ABSTRACT

Methods, systems, and devices for delayed memory management operations are described. A memory system may be configured to delay one or more aspects of a memory management operation and correspondingly adjust a rate of write operation performance. The memory system may delay updating L2P table entries until a first set of memory cells is full. During a memory management operation, the memory system may transfer a set of logical-to-physical (L2P) address updates to a second set of memory cells. In response to determining that the first set of memory cells is full, the memory system may read the second set of memory cells or the first set of memory cells to obtain the L2P updates. The memory system may be configured to update a rate of write operation performance based on the delayed memory management operations.

### CROSS REFERENCE

The present Application for Patent claims priority to U.S. Patent Application No. 63/674,709 by Palmer, entitled “DELAYED MEMORY MANAGEMENT OPERATIONS,” filed Jul. 23, 2024, which is assigned to the assignee hereof, and which is expressly incorporated by reference in its entirety herein.

### TECHNICAL FIELD

The following relates to one or more systems for memory, including delayed memory management operations.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIGS. 1 and 2 show examples of systems that support delayed memory management operations in accordance with examples as disclosed herein.

FIG. 3 shows an example of a process flow that supports delayed memory management operations in accordance with examples as disclosed herein.

FIG. 4 shows a block diagram of a memory system that supports delayed memory management operations in accordance with examples as disclosed herein.

FIGS. 5 through 7 show flowcharts illustrating a method or methods that support delayed memory management operations in accordance with examples as disclosed herein.

### DETAILED DESCRIPTION

In some memory systems (e.g., not-AND (NAND) systems), memory cells may be capable of storing multiple bits of information (e.g., multi-level cells (MLCs), tri-level cells (TLCs), quad-level cells (QLC)). However, such memory cells may be associated with relatively low reliability (e.g., due to relatively unstable charge distribution) as compared to other memory cells (e.g., single-level cells (SLCs)). Accordingly, a memory system may utilize such memory cells for internal operations such as memory management operations. For instance, as part of a garbage collection operation, a memory system may maintain (e.g., store, update) logical-to-physical (L2P) address mapping data (e.g., L2P tables) in a block of multi-level memory cells (e.g., a QLC block). As multi-level memory cell blocks continue to increase in size, a workload associated with memory management operations may also increase (e.g., in terms of processing duration). However, some memory systems may not be configured to dynamically account for the increased memory management workload, which may impact an ability of the memory system to perform host work (e.g., host read operations, host write operations). For instance, the increased memory management workload may inhibit (e.g., or prevent) the memory system from processing host operations (e.g., receiving write data, transmitting read data, executing read and write commands), thus increasing latency and degrading user experience.

In accordance with one or more techniques described herein, a memory system may be configured to delay one or more aspects of a memory management operation and adjust (e.g., update, modify, increase, decrease) a rate of performing various operations based on the delayed operations. For example, the memory system may delay updating L2P table entries until set of memory cells (e.g., a block of memory cells, a QLC block) is full. In some examples, as part of a memory management operation, the memory system may write (e.g., store, log) a set of L2P address updates in a temporary buffer and may continue to perform the memory management operation until a first set of memory cells is full. During the operation, the memory system may periodically transfer the data (e.g., flush the data based on filling the buffer) from the temporary to a second set of memory cells (e.g., a second block of memory cells, an SLC block). Based on (e.g., in response to) determining that the first set of memory cells is full, the updated L2P data stored in the second set of memory cells may be output (e.g., transferred, transmitted, pushed) to a change log manager, which may update the corresponding L2P data at the L2P tables. Alternatively, in response to determining that the first set of memory cells is full, the memory system may read the first set of memory cells (e.g., the entire QLC block) to obtain the L2P updates. The memory system may output the obtained L2P updates to the change log manager. In some examples, the memory system may be further configured to update a rate at which it accepts commands and/or data from a host system based on the delayed memory management operations. Thus, by enabling the memory system to dynamically adjust a workload based on a memory management operation, a memory system support more efficient memory management operations for relatively large blocks while maintaining a flow of data and commands received from the host system. Accordingly, the memory system may support improved data integrity, improved reliability, reduced latency, and enhanced user experience, among other benefits.

In addition to applicability in memory systems as described herein, techniques for delayed memory management operations may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by maintaining a continuous flow of data between the host system and the memory system, which may decrease processing and latency times, improve response times, and otherwise improve user experience, among other benefits.

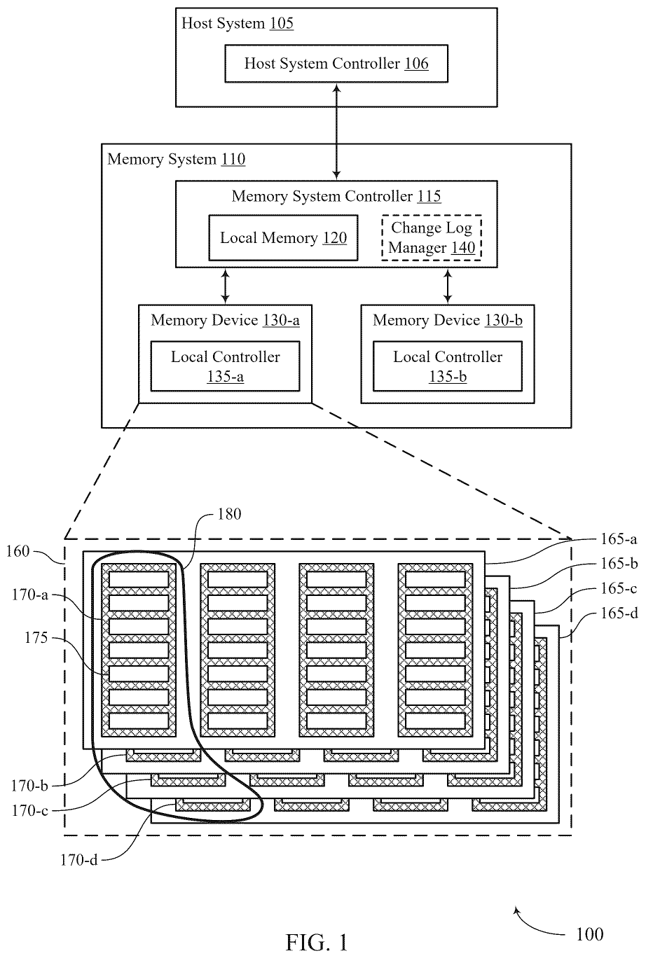

FIG. 1 shows an example of a system 100 that supports delayed memory management operations in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as SLCs. Additionally, or alternatively, a NAND memory device 130 may include memory cells configured to each store multiple bits of information, which may be referred to as MLCs if configured to each store two bits of information, as TLCs if configured to each store three bits of information, as QLCs if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a L2P mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is an MNAND system.

Some memory systems 110 may include a block 170 of memory cells (e.g., in a memory device 130) that support storage of multiple bits of information, which may be associated with relatively low reliability. Accordingly, the memory system 110 may utilize such blocks 170 (e.g., QLC blocks) for memory management operations, such as garbage collection. For instance, the memory system 110 may maintain L2P table entries in one or more blocks 170 that store multiple bits. However, such blocks 170 may be relatively large, and performing internal management operations on the blocks 170 may inhibit (e.g., or prevent) the memory system 110 from receiving data and/or commands from the host system 105, which may increase latency and reduce performance of the system 100.

In accordance with one or more techniques described herein, a memory system 110 (e.g., a memory system controller 115) may be configured to delay a memory management operation (e.g., an L2P update operation) and adjust a rate of performing work for the host system 105 (e.g., external operations) based on the delayed operations. For example, while performing a memory management operation for a first block 170, the memory system 110 may store L2P address updates in a second block 170 (e.g., an SLC block). When the first block 170 is full, the memory system 110 may output the L2P updates to a change log manager 140, which may subsequently update the corresponding L2P data. Alternatively, in response to determining that the first block 170 is full, the memory system 110 may read the entire first block 170 (e.g., as part of a single read operation) to obtain the L2P updates. The memory system 110 may output the L2P updates obtained from reading the block 170 to the change log manager 140. The memory system 110 may be further configured to update a rate at which it accepts commands and/or data from the host system 105 based on a workload associated with the memory management operations. Thus, the system 100 may support memory management operations for relatively large blocks 170 while maintaining a flow of commands between the host system 105 and the memory system 110, thereby supporting improved reliability, reduced latency, enhanced user experience, and other benefits.

The system 100 may include any quantity of non-transitory computer readable media that support delayed memory management operations. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

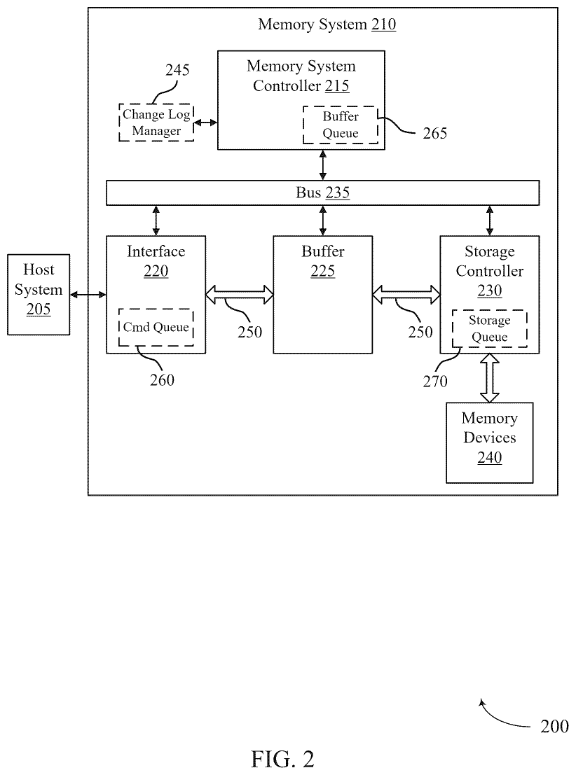

FIG. 2 shows an example of a system 200 that supports delayed memory management operations in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210 and the host system 205 may be examples of the memory system 110 and the host system 105, respectively.

The memory system 210 may include one or more memory devices 240 to store data transferred between the memory system 210 and the host system 205 (e.g., in response to receiving access commands from the host system 205). The memory devices 240 may include one or more memory devices as described with reference to FIG. 1. For example, the memory devices 240 may include NAND memory, PCM, self-selecting memory, 3D cross point or other chalcogenide-based memories, FERAM, MRAM, NOR (e.g., NOR flash) memory, STT-MRAM, CBRAM, RRAM, or OxRAM, among other examples.

The memory system 210 may include a storage controller 230 for controlling the passing of data directly to and from the memory devices 240 (e.g., for storing data, for retrieving data, for determining memory locations in which to store data and from which to retrieve data). The storage controller 230 may communicate with memory devices 240 directly or via a bus (not shown), which may include using a protocol specific to each type of memory device 240. In some cases, a single storage controller 230 may be used to control multiple memory devices 240 of the same or different types. In some cases, the memory system 210 may include multiple storage controllers 230 (e.g., a different storage controller 230 for each type of memory device 240). In some cases, a storage controller 230 may implement aspects of a local controller 135 as described with reference to FIG. 1.

The memory system 210 may include an interface 220 for communication with the host system 205, and a buffer 225 for temporary storage of data being transferred between the host system 205 and the memory devices 240. The interface 220, buffer 225, and storage controller 230 may support translating data between the host system 205 and the memory devices 240 (e.g., as shown by a data path 250), and may be collectively referred to as data path components.

Using the buffer 225 to temporarily store data during transfers may allow data to be buffered while commands are being processed, which may reduce latency between commands and may support arbitrary data sizes associated with commands. This may also allow bursts of commands to be handled, and the buffered data may be stored, or transmitted, or both (e.g., after a burst has stopped). The buffer 225 may include relatively fast memory (e.g., some types of volatile memory, such as SRAM or DRAM), or hardware accelerators, or both to allow fast storage and retrieval of data to and from the buffer 225. The buffer 225 may include data path switching components for bi-directional data transfer between the buffer 225 and other components.

A temporary storage of data within a buffer 225 may refer to the storage of data in the buffer 225 during the execution of access commands. For example, after completion of an access command, the associated data may no longer be maintained in the buffer 225 (e.g., may be overwritten with data for additional access commands). In some examples, the buffer 225 may be a non-cache buffer. For example, data may not be read directly from the buffer 225 by the host system 205. In some examples, read commands may be added to a queue without an operation to match the address to addresses already in the buffer 225 (e.g., without a cache address match or lookup operation).

The memory system 210 also may include a memory system controller 215 for executing the commands received from the host system 205, which may include controlling the data path components for the moving of the data. The memory system controller 215 may be an example of the memory system controller 115 as described with reference to FIG. 1. A bus 235 may be used to communicate between the system components.

In some cases, one or more queues (e.g., a command queue 260, a buffer queue 265, a storage queue 270) may be used to control the processing of access commands and the movement of corresponding data. This may be beneficial, for example, if more than one access command from the host system 205 is processed concurrently by the memory system 210. The command queue 260, buffer queue 265, and storage queue 270 are depicted at the interface 220, memory system controller 215, and storage controller 230, respectively, as examples of a possible implementation. However, queues, if implemented, may be positioned anywhere within the memory system 210.

Data transferred between the host system 205 and the memory devices 240 may be conveyed along a different path in the memory system 210 than non-data information (e.g., commands, status information). For example, the system components in the memory system 210 may communicate with each other using a bus 235, while the data may use the data path 250 through the data path components instead of the bus 235. The memory system controller 215 may control how and if data is transferred between the host system 205 and the memory devices 240 by communicating with the data path components over the bus 235 (e.g., using a protocol specific to the memory system 210).

If a host system 205 transmits access commands to the memory system 210, the commands may be received by the interface 220 (e.g., according to a protocol, such as a UFS protocol or an eMMC protocol). Thus, the interface 220 may be considered a front end of the memory system 210. After receipt of each access command, the interface 220 may communicate the command to the memory system controller 215 (e.g., via the bus 235). In some cases, each command may be added to a command queue 260 by the interface 220 to communicate the command to the memory system controller 215.

The memory system controller 215 may determine that an access command has been received based on the communication from the interface 220. In some cases, the memory system controller 215 may determine the access command has been received by retrieving the command from the command queue 260. The command may be removed from the command queue 260 after it has been retrieved (e.g., by the memory system controller 215). In some cases, the memory system controller 215 may cause the interface 220 (e.g., via the bus 235) to remove the command from the command queue 260.

After a determination that an access command has been received, the memory system controller 215 may execute the access command. For a read command, this may include obtaining data from one or more memory devices 240 and transmitting the data to the host system 205. For a write command, this may include receiving data from the host system 205 and moving the data to one or more memory devices 240. In either case, the memory system controller 215 may use the buffer 225 for, among other things, temporary storage of the data being received from or sent to the host system 205. The buffer 225 may be considered a middle end of the memory system 210. In some cases, buffer address management (e.g., pointers to address locations in the buffer 225) may be performed by hardware (e.g., dedicated circuits) in the interface 220, buffer 225, or storage controller 230.

To process a write command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the write command.

In some cases, a buffer queue 265 may be used to control a flow of commands associated with data stored in the buffer 225, including write commands. The buffer queue 265 may include the access commands associated with data currently stored in the buffer 225. In some cases, the commands in the command queue 260 may be moved to the buffer queue 265 by the memory system controller 215 and may remain in the buffer queue 265 while the associated data is stored in the buffer 225. In some cases, each command in the buffer queue 265 may be associated with an address at the buffer 225. For example, pointers may be maintained that indicate where in the buffer 225 the data associated with each command is stored. Using the buffer queue 265, multiple access commands may be received sequentially from the host system 205 and at least portions of the access commands may be processed concurrently.

If the buffer 225 has sufficient space to store the write data, the memory system controller 215 may cause the interface 220 to transmit an indication of availability to the host system 205 (e.g., a “ready to transfer” indication), which may be performed in accordance with a protocol (e.g., a UFS protocol, an eMMC protocol). As the interface 220 receives the data associated with the write command from the host system 205, the interface 220 may transfer the data to the buffer 225 for temporary storage using the data path 250. In some cases, the interface 220 may obtain (e.g., from the buffer 225, from the buffer queue 265) the location within the buffer 225 to store the data. The interface 220 may indicate to the memory system controller 215 (e.g., via the bus 235) if the data transfer to the buffer 225 has been completed.

After the write data has been stored in the buffer 225 by the interface 220, the data may be transferred out of the buffer 225 and stored in a memory device 240, which may involve operations of the storage controller 230. For example, the memory system controller 215 may cause the storage controller 230 to retrieve the data from the buffer 225 using the data path 250 and transfer the data to a memory device 240. The storage controller 230 may be considered a back end of the memory system 210. The storage controller 230 may indicate to the memory system controller 215 (e.g., via the bus 235) that the data transfer to one or more memory devices 240 has been completed.

In some cases, a storage queue 270 may support a transfer of write data. For example, the memory system controller 215 may push (e.g., via the bus 235) write commands from the buffer queue 265 to the storage queue 270 for processing. The storage queue 270 may include entries for each access command. In some examples, the storage queue 270 may additionally include a buffer pointer (e.g., an address) that may indicate where in the buffer 225 the data associated with the command is stored and a storage pointer (e.g., an address) that may indicate the location in the memory devices 240 associated with the data. In some cases, the storage controller 230 may obtain (e.g., from the buffer 225, from the buffer queue 265, from the storage queue 270) the location within the buffer 225 from which to obtain the data. The storage controller 230 may manage the locations within the memory devices 240 to store the data (e.g., performing wear-leveling, performing garbage collection). The entries may be added to the storage queue 270 (e.g., by the memory system controller 215). The entries may be removed from the storage queue 270 (e.g., by the storage controller 230, by the memory system controller 215) after completion of the transfer of the data.

To process a read command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the read command.

In some cases, the buffer queue 265 may support buffer storage of data associated with read commands in a similar manner as discussed with respect to write commands. For example, if the buffer 225 has sufficient space to store the read data, the memory system controller 215 may cause the storage controller 230 to retrieve the data associated with the read command from a memory device 240 and store the data in the buffer 225 for temporary storage using the data path 250. The storage controller 230 may indicate to the memory system controller 215 (e.g., via the bus 235) when the data transfer to the buffer 225 has been completed.

In some cases, the storage queue 270 may be used to aid with the transfer of read data. For example, the memory system controller 215 may push the read command to the storage queue 270 for processing. In some cases, the storage controller 230 may obtain (e.g., from the buffer 225, from the storage queue 270) the location within one or more memory devices 240 from which to retrieve the data. In some cases, the storage controller 230 may obtain (e.g., from the buffer queue 265) the location within the buffer 225 to store the data. In some cases, the storage controller 230 may obtain (e.g., from the storage queue 270) the location within the buffer 225 to store the data. In some cases, the memory system controller 215 may move the command processed by the storage queue 270 back to the command queue 260.

After the data has been stored in the buffer 225 by the storage controller 230, the data may be transferred from the buffer 225 and sent to the host system 205. For example, the memory system controller 215 may cause the interface 220 to retrieve the data from the buffer 225 using the data path 250 and transmit the data to the host system 205 (e.g., according to a protocol, such as a UFS protocol or an eMMC protocol). For example, the interface 220 may process the command from the command queue 260 and may indicate to the memory system controller 215 (e.g., via the bus 235) that the data transmission to the host system 205 has been completed.

The memory system controller 215 may execute received commands according to an order (e.g., a first-in-first-out order, according to the order of the command queue 260). For each command, the memory system controller 215 may cause data corresponding to the command to be moved into and out of the buffer 225, as discussed herein. As the data is moved into and stored within the buffer 225, the command may remain in the buffer queue 265. A command may be removed from the buffer queue 265 (e.g., by the memory system controller 215) if the processing of the command has been completed (e.g., if data corresponding to the access command has been transferred out of the buffer 225). If a command is removed from the buffer queue 265, the address previously storing the data associated with that command may be available to store data associated with a new command.

In some examples, the memory system controller 215 may be configured for operations associated with one or more memory devices 240. For example, the memory system controller 215 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 205 and physical addresses (e.g., physical block addresses) associated with memory cells within the memory devices 240. For example, the host system 205 may issue commands indicating one or more LBAs and the memory system controller 215 may identify one or more physical block addresses indicated by the LBAs. In some cases, one or more contiguous LBAs may correspond to noncontiguous physical block addresses. In some cases, the storage controller 230 may be configured to perform one or more of the described operations in conjunction with or instead of the memory system controller 215. In some cases, the memory system controller 215 may perform the functions of the storage controller 230 and the storage controller 230 may be omitted.

Some memory systems 210 may include a block of memory cells (e.g., in a memory device 240) that support storage of multiple bits of information, which may be associated with relatively low reliability. Accordingly, the memory system 210 may utilize such blocks (e.g., QLC blocks) for memory management operations, such as garbage collection. However, such blocks may be relatively large, and performing internal management operations on the blocks may inhibit (e.g., or prevent) the memory system 210 from receiving data and/or commands from the host system 205.

In accordance with one or more techniques described herein, a memory system 210 (e.g., a memory system controller 215) may be configured to delay a memory management operation (e.g., an L2P update operation) and adjust a rate of performing work for the host system 205 (e.g., external operations). For example, while performing a memory management operation for a first block, the memory system 210 may store L2P address updates in a second block (e.g., an SLC block). When the first block is full, the memory system 210 may output the L2P updates to a change log manager 245, which may subsequently update the corresponding L2P data. In some examples, the change log manager 245 may be included in (e.g., implemented in), or coupled with, one or more components of the memory system 210 (e.g., the memory system controller 215, the storage controller 230, the memory devices 240). Alternatively, in response to determining that the first block is full, the memory system 210 may read the entire first block to obtain the L2P updates and output the updates to the change log manager 245. In each technique, the memory system 210 may be further configured to update a rate at which it accepts commands and/or data from the host system 205 based on a workload associated with the memory management operation, which may improve performance of the system 200 by enhancing response times and increasing reliability of the memory devices 240, among other benefits.

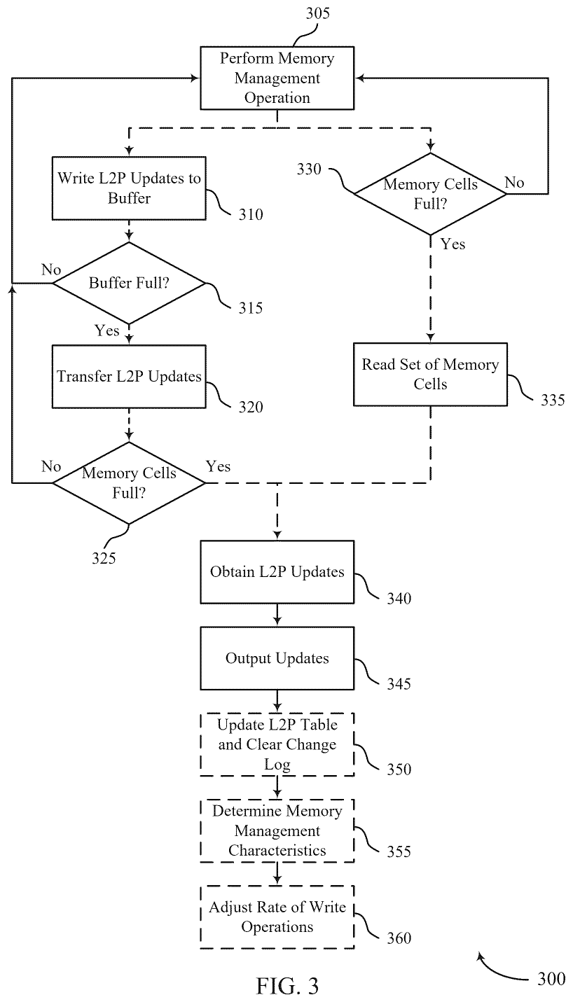

FIG. 3 shows an example of a process flow 300 that supports delayed memory management operations in accordance with examples as disclosed herein. In some examples, the process flow 300 may be performed by a memory system as described herein (e.g., memory system 110, a memory system 210, or some other component as described with reference to FIGS. 1 and 2). Aspects of the process flow 300 may be implemented by one or more controllers (e.g., a memory system controller 115, a memory system controller 215), among other components. Additionally, or alternatively, aspects of the process flow 300 may be implemented as instructions stored in one or more memories (e.g., firmware stored in one or more memories coupled with a memory system). For example, the instructions, when executed by one or more controllers (e.g., the memory system controller 115, the memory system controller 215), may cause the one or more controllers (e.g., or a device or a system) to perform the operations of the process flow 300.

A memory system may support sets of memory cells (e.g., blocks) that store multiple bits of information such as QLCs (e.g., or other memory cells types that support multi-bit storage). In some cases, a performance of such cells (e.g., QLC media health) may be associated with several challenges including unstable charge distribution and relatively poor read performance. To mitigate such issues, the memory system may perform multiple write operations (e.g., multiple passes) to store information to a QLC (e.g., or other similar cell), which may lead to an inability to read data from a not-fully-programmed block. Accordingly, QLCs may be utilized as (e.g., suitable for) a destination for memory management operations such as garbage collection and folding operations.

A garbage collection may be associated with maintaining one or more L2P tables, which may store L2P address mappings for the memory system. In some cases, an L2P table entry may not point to (e.g., support a mapping to) an open QLC block. Thus, the memory system may delay L2P table updates associated with the garbage collection until the entire QLC block is full. Additionally, QLC blocks may continue to increase in size (e.g., in terms of a quantity of memory cells). As QLC blocks increase in size, garbage collection operations performed on the QLC block may proportionally increase (e.g., in terms of duration and other processing resources).

In some cases, the performance of memory management operations may affect an ability of the memory system to perform work for an external device. For instance, the memory system may utilize the same processing resources to perform internal operations and operations for a host device. Accordingly, an increase memory management operations may result in a decrease in host operations performed by the memory system. Thus, the memory system may be expected to maintain a balance between performing internal operations and performing operations for the host system. Such a balance may be described in terms of a cadence of the memory system. A “cadence” may refer to a ratio of host work operations to memory management operations (e.g., internal garbage collection, internal work) performed by the memory system. The cadence may measure of the balance between the two types of operations to ensure that the memory system can continue to receive host data at a consistent rate while performing a garbage collection operation.

Some memory systems, however, may not be configured to dynamically account for changes (e.g., increases) to a memory management workload, which may affect an ability of the memory system to perform host work (e.g., host read operations, host write operations, receiving host data). For instance, internal garbage collection operations associated with relatively large sets of memory cells (e.g., large QLC blocks) may occupy a significant portion of processing resources at the memory system, which may interrupt, inhibit, or otherwise hinder one or more host operations. Thus, without an ability to dynamically adjust a cadence of host operation and memory management operations, the memory system may operate with increased latency, reduced reliability, and reduced performance.

In accordance with techniques described herein, a memory system may support one or more operations of the process flow 300 to enable more efficient memory management operations and to adjust a cadence of the memory system based on characteristics of the memory management operations. Alternative examples of the following description may be implemented. For example, some of the described steps may be performed in a different order or are not performed at all. In some implementations, some of the steps may include additional features not mentioned below, or further steps may be added. In some aspects, the process flow 300 may describe a checkpoint-based L2P update procedure, where a “checkpoint” may refer to a process in which updates to an L2P table are performed together in a batch (e.g., rather than immediately after detection). Such checkpoints may reduce table write traffic and improve performance.

At 305, a memory management operation (e.g., a garbage collection procedure) may be performed (e.g., initiated). For example, a memory system may perform the memory management operation for a first set (e.g., a first block) of one or more memory cells (e.g., QLCs, a QLC block). In some examples, the first set of memory cells may correspond to NAND memory cells to not-AND (NAND) memory cells. For example, the first set of memory cells may correspond to QLCs, which may be associated with a NAND memory system. The memory system may support various techniques to delay L2P updates (e.g., the checkpointing of L2P updates) associated with the first set of memory cells (e.g., QLC garbage collection on virtual blocks). In a first technique (e.g., if the memory system utilizes a second block of memory cells to store L2P updates), the memory system may proceed to 310. In a second technique (e.g., if the memory system obtains the L2P updates from the QLCs themselves), the memory system may proceed to 330. Alternatively, the memory system may utilize a combination of the various techniques described herein.

At 310, in accordance with a first technique, one or more L2P address updates may be written to a buffer (e.g., a temporary buffer). That is, while the memory system is performing the memory management procedure (e.g., garbage collection), the memory system may write (e.g., push) one or more L2P address updates (e.g., change log entries) into a temporary buffer and may proceed to 315. At 315, a determination of whether the buffer is full may be performed. For example, the memory system may determine (e.g., identify) whether the buffer is full based on (e.g., after, in direct response to) writing the one or more L2P address updates to the buffer. If the buffer is full, the memory system may proceed to 320, otherwise the memory system may return to 305.

At 320, the one or more L2P address updates may be transferred. For example, the memory system may transfer the one or more L2P address updates from the buffer to a second set of one or more memory cells (e.g., SLCs, an SLC block, NAND memory cells) based on (e.g., in response to) determining that the buffer is full (e.g., or that the buffer satisfies a threshold). In other words, the memory system may flush the L2P address updates from the buffer to a separate set of memory cells (e.g., a static SLC block, an incomplete virtual block, a full virtual block used as a cache space, a giant change log in SLCs). In such examples (e.g., in accordance with the first technique), the first set of one or more memory cells may corresponds to cells having two or more levels (e.g., cells that are configured to store two or more bits of information, QLCs) and the second set of one or more memory cells may correspond to SLCs.

At 325, a determination of whether the first set of one or more memory cells is full (e.g., whether all of the QLCs have been programed) may be performed. For example, the memory system may determine whether the first set of cells is full based on (e.g., in response to, in accordance with, as part of) performing the memory management operation. That is, the memory system may perform a garbage collection operation until the first set of memory cells (e.g., the QLC block) is filled (e.g., until everything is readable in the QLC, until each of the multiple write passes have fully completed). If the memory system determines that the first set of memory cells is full, the memory system may proceed to 340, otherwise the memory system may return to 305. In some examples, the first technique may be associated with relatively fewer operations (e.g., change log traffic may be smaller than a full QLC block). Additionally, the memory system may perform sorting operations on the data stored in the buffer (e.g., the change log cache memory) prior to transferring to SLC, which may reduce processing time.

At 330, in accordance with a second technique, a determination of whether the first set of one or more memory cells is full may be performed. That is, the memory system may perform a garbage collection operation until the first set of memory cells (e.g., the QLC block) is filled, and this may occur without monitoring for L2P table updates. In some examples, the memory system may determine whether the first set of cells is full based on (e.g., in response to, in accordance with, as part of) performing the memory management operation. If the memory system determines that the first set of memory cells is full, the memory system may proceed to 335, otherwise the memory system may return to 305.

At 335, the first set of memory cells may be read. For example, once the first set of memory cells (e.g., the QCL block) is filled, the memory system may read back the entire first set of cells (e.g., obtaining at least one or more LBAs associated with the L2P updates). That is, the memory system may read the first set of one or more memory cells based on (e.g., in response to, after) determining that the first set of one or more memory cells is full. In such examples (e.g., in the second technique), the first set of one or more memory cells may corresponds to cells having two or more levels (e.g., may be QLCs). In some examples, the second technique may utilize a change log without modifications, and the memory system may perform an additional media health scan based on reading the QLC block.

At 340, a set of L2P address updates may be obtained. For example, the memory system may obtain one or more L2P address updates from a set of one or more memory cells (e.g., a second set of memory cells different from the first set, or the first set of memory cells itself) based on (e.g., in response to, after) determining that the first set of one or more memory cells is full. That is, in accordance with the first technique (e.g., beginning at 310), once the QLC block is filled, the memory system may read back an extended change log memory from the second set of memory cells (e.g., SLCs). As described, the second set of memory cells (e.g., SLCs) may be different from the first set of cells (e.g., QLCs, the set of cells on which the garbage collection is performed). In accordance with the second technique, the memory system may obtain the L2P address updates from the first set of cells itself (e.g., QLCs, at 335). At 345, the L2P address updates may be output to a change log (e.g., a change log manager). For example, the memory system (e.g., or a memory system controller) may output (e.g., push) the set of L2P address updates to the change log based on (e.g., in direct response to) obtaining the set of L2P address updates (e.g., from the SLC block, from the QLC block).

At 350, a L2P table may be updated and the change log may be cleared. For example, the memory system may determine whether the change log is full based on (e.g., in direct response to, after) outputting the set of L2P address updates to the change log. If the change log is full, the memory system may update an L2P address mapping table and may clear (e.g., flush) the change log based on (e.g., in direct response to) updating the L2P address mapping table. If the change log is not full, the memory system may continue to receive L2P address updates until filled.

At 355, one or more memory management characteristics may be determined (e.g., identified, calculated). For example, based on the delayed L2P updates, the memory system may modify a cadence. The cadence may account for both a time to fill the first set of memory cells (e.g., the QLC garbage collection destination block) and also the L2P address update operation (e.g., the checkpoint), which may process (e.g., flush) the L2P table updates. In some examples, the memory system may determine a size of the first set of cells (e.g., the QLC block) and a size of a cached change log (e.g., the SLC block). Accordingly, a workload for the read operations and write operations may be determined and accounted for in the cadence.

In some examples, a memory management characteristic may be associated with storage that may be freed once a set of memory cells (e.g., eventual source blocks) is freed. The freed space may be determined based on a quantity of valid data (e.g., valid data counts) at the beginning of a garbage collection operation. In some examples, a memory management characteristic may be associated with a duration associated with reading data from a set of memory cells (e.g., the source blocks). The duration may be determined from the valid data counts at beginning of the garbage collection operation and block type (e.g., SLC, TLC, QLC). In some examples, a memory management characteristic may be associated with a duration to fill the first set of memory cells (e.g., a QLC destination block), which the memory system may determine as a function of write bandwidth (e.g., QLC write bandwidth) and a size of the first set of memory cells (e.g., destination block size). For example, the memory system may determine a quantity of valid data associated with the first set of one or more memory cells based on (e.g., after, during at least a portion of a duration) performing the memory management operation, a first memory cell type associated with the first set of one or more memory cells, and a second memory cell type associated with the second set of one or more memory cells (e.g., if supported, a set of memory cells where the L2P address updates are stored).

In some examples, a memory management characteristic may correspond to a workload associated with the delayed L2P address update operation (e.g., the checkpoint may also participate in cadence determination). For example, at manufacturing time, a manufacturer may assess a target workload to estimate a size of work associated with the delayed L2P address updates (e.g., in terms of a quantity of checkpoint flushes expected to be performed). At run time, the memory system may measure an actual workload (e.g., checkpoint work for QLC garbage collection block closure) as a quantity (e.g., count) of change log flushes (e.g., checkpoint flushes) and may periodically adjust an expected size associated with the L2P address update operations (e.g., checkpoint size). In some examples, the memory system may determine whether a workload associated with clearing the change log corresponds to (e.g., satisfies, matches, fails to satisfy) a threshold workload. Accordingly, the cadence may dynamically react to instantaneous checkpoint efficiency.

In some examples, a cadence (e.g., ratio of host work to internal work) during the memory management operations (e.g., QLC garbage collection) of the memory system may be estimated as a function (e.g., a linear combination, in a point scale) of one or more factors impacting a rate at which host space can be freed up for future writes to one or more memory cells (e.g., SLCs, TLCs). As an example, internal work may be associated with a size of work to free up host space, which may be determined based on the equation: internal work=(x0*SLC reads)+(x1*SLC writes)+(x2*SLC erases)+(x3*TLC reads)+(x4*TLC writes)+(x5*TLC erases)+(x6*QLC reads)+ (x7*QLC writes)+(x8*QLC erases). Further, host work may be determined based on the equation: host work=(y0*SLC writes)+(y1*TLC writes). In such examples, {x0, x1, . . . , x8} and {y0, y1} may be selected based on relative costs (e.g., latency, energy, overhead) of each corresponding operation in accordance with a capability of the memory system (e.g., NAND capability, firmware capability, controller capability).

In some examples, the cadence may be described in terms of a workload ratio. For example, during a memory management operation, the memory system may calculate a first workload associated with finishing a QLC garbage collection operation as some budget of internal work (e.g., device work). The memory system may further calculate a second workload associated with to receiving new host writes (e.g., host write data, host write commands) as some budget of host work. The memory system may calculate the workload ratio in terms of the second workload to the first workload (e.g., host work to internal work), which may be used as the cadence of the memory system. As the memory system completes host work and internal work, the memory system may adjust a respective value for the corresponding workload.

At 360, a rate of performing write operations (e.g., for a host system, a cadence) may be adjusted. In some examples, the memory system may monitor (e.g., measure, track) a workload ratio (e.g., a cadence) associated with the memory management operations (e.g., internal garbage collection operations) and write operations associated with an external device. For instance, if a memory management operation (e.g., a checkpoint) lasts longer than expected (e.g., more change log flushes than expected), the memory system may increase a budget for internal work (e.g., memory system work) and decrease a budget for host work (e.g., write operations, receiving write data or commands). As a non-limiting example, if an estimated workload (e.g., cost) of doing a checkpoint (e.g., a delayed L2P address update operation) is 1000 and 20 checkpoints are expected, a checkpoint budget may be 20000. If an actual estimated quantity of checkpoints (e.g., based on progress through QLC block) increases to 40 checkpoints, the memory system may add another 20000 to the device budget and may recalculate the cadence mid-checkpoint. This may slow the host work (e.g., reduce a rate of accepting write data) to account for the larger-than-expected checkpoint, but may not halt the host completely. Accordingly, future estimated checkpoints per garbage collection block may be incremented when this occurs. Additionally, the memory system may reduce checkpoint budget if a checkpoint is performed faster than expected (e.g., faster than a threshold).

In some examples, the memory system may adjust the rate of performing write operations based on (e.g., in accordance with) the memory management characteristics described herein. For example, the rate may be adjusted based on the quantity of valid data, the first memory cell type, the second memory cell type, based on whether the workload associated with clearing the change log (e.g., a quantity of change log flushes) satisfies a threshold workload (e.g., a threshold quantity), a workload ratio of the device (e.g., to achieve a target workload ratio), or any combination thereof. As each memory management operation is completed (e.g., checkpointed) for a source block (e.g., based on a quantity of updates and a size of valid data in source block) source blocks may be released, erased, and receive new host or internal writes.

Accordingly, a memory system may be configured to perform relatively large garbage collection operations without preventing a performance of work for an external device. Additionally, the one or more techniques described herein may enable QLC destination blocks to be fully closed before performing host reads. Moreover, the memory system may be enabled to accept new host data while preforming memory management operations, which may allow the memory system to perform memory management operations (e.g., checkpoint-aware cadence) more frequently. Thus, the memory system may operate with reduced latency and improved response times, and other benefits.

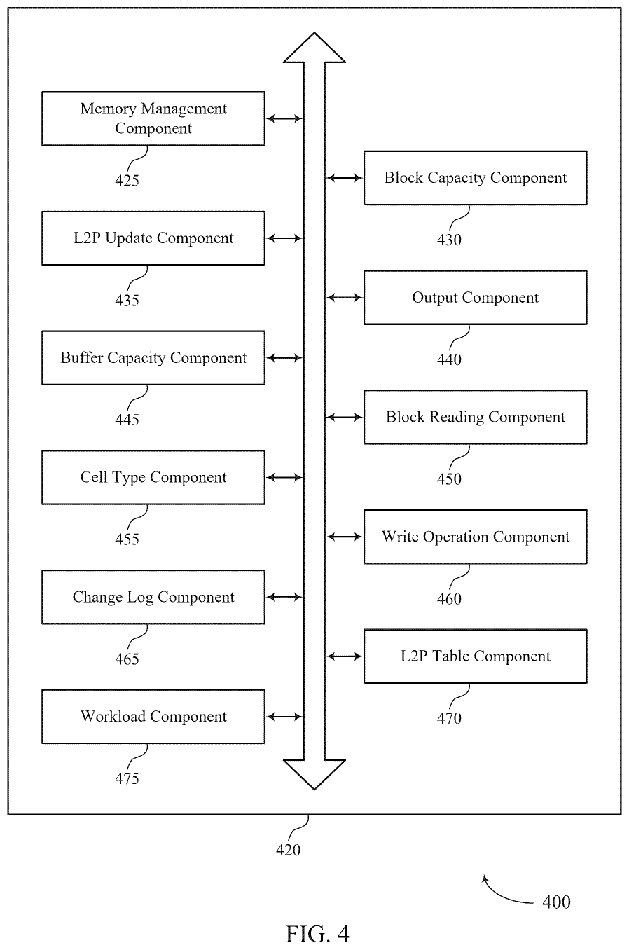

FIG. 4 shows a block diagram 400 of a memory system 420 that supports delayed memory management operations in accordance with examples as disclosed herein. The memory system 420 may be an example of aspects of a memory system as described with reference to FIGS. 1 through 3. The memory system 420, or various components thereof, may be an example of means for performing various aspects of delayed memory management operations as described herein. For example, the memory system 420 may include a memory management component 425, a block capacity component 430, a L2P update component 435, an output component 440, a buffer capacity component 445, a block reading component 450, a cell type component 455, a write operation component 460, a change log component 465, a L2P table component 470, a workload component 475, or any combination thereof. Each of these components, or components of subcomponents thereof (e.g., one or more processors, one or more memories), may communicate, directly or indirectly, with one another (e.g., via one or more buses).

The memory management component 425 may be configured as or otherwise support a means for performing a memory management operation for a first set of one or more memory cells. The block capacity component 430 may be configured as or otherwise support a means for determining whether the first set of one or more memory cells is full in response to performing the memory management operation. The L2P update component 435 may be configured as or otherwise support a means for obtaining a set of logical-to-physical address updates from a second set of one or more memory cells in response to determining that the first set of one or more memory cells is full. The output component 440 may be configured as or otherwise support a means for outputting the set of logical-to-physical address updates to a change log in response to obtaining the set of logical-to-physical address updates from the second set of one or more memory cells.

In some examples, the first set of one or more memory cells corresponds to cells having two or more levels and the second set of one or more memory cells corresponds to single-level cells, and the L2P update component 435 may be configured as or otherwise support a means for writing, during the memory management operation, one or more logical-to-physical address updates to a buffer. In some examples, the first set of one or more memory cells corresponds to cells having two or more levels and the second set of one or more memory cells corresponds to single-level cells, and the buffer capacity component 445 may be configured as or otherwise support a means for determining whether the buffer is full in response to writing the one or more logical-to-physical address updates. In some examples, the first set of one or more memory cells corresponds to cells having two or more levels and the second set of one or more memory cells corresponds to single-level cells, and the L2P update component 435 may be configured as or otherwise support a means for transferring the one or more logical-to-physical address updates from the buffer to the second set of one or more memory cells in response to determining that the buffer is full.

In some examples, the first set of one or more memory cells corresponds to cells having two or more levels, and the block reading component 450 may be configured as or otherwise support a means for reading the first set of one or more memory cells in response to determining that the first set of one or more memory cells is full.

In some examples, the memory management component 425 may be configured as or otherwise support a means for determining a quantity of valid data associated with the first set of one or more memory cells in accordance with performing the memory management operation. In some examples, the cell type component 455 may be configured as or otherwise support a means for determining a first memory cell type associated with the first set of one or more memory cells and a second memory cell type associated with the second set of one or more memory cells. In some examples, the write operation component 460 may be configured as or otherwise support a means for adjusting a rate of performing write operations in accordance with the quantity of valid data, the first memory cell type, and the second memory cell type.

In some examples, the change log component 465 may be configured as or otherwise support a means for determining whether the change log is full in response to outputting the set of logical-to-physical address updates to the change log. In some examples, the L2P table component 470 may be configured as or otherwise support a means for updating a logical-to-physical address mapping table in response to determining that the change log is full. In some examples, the change log component 465 may be configured as or otherwise support a means for clearing the change log in response to updating the logical-to-physical address mapping table.

In some examples, the workload component 475 may be configured as or otherwise support a means for determining whether a workload associated with clearing the change log corresponds to a threshold workload. In some examples, the workload component 475 may be configured as or otherwise support a means for adjusting a rate of performing write operations in response to determining that the workload satisfies the threshold workload.

In some examples, the workload component 475 may be configured as or otherwise support a means for adjusting a rate of performing write operations in accordance with a workload ratio.

In some examples, the first set of one or more memory cells and the second set of one or more memory cells corresponds to not-AND (NAND) memory cells. In some examples, the first set of one or more memory cells corresponds to quad-level cells and the second set of one or more memory cells corresponds to single-level cells.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

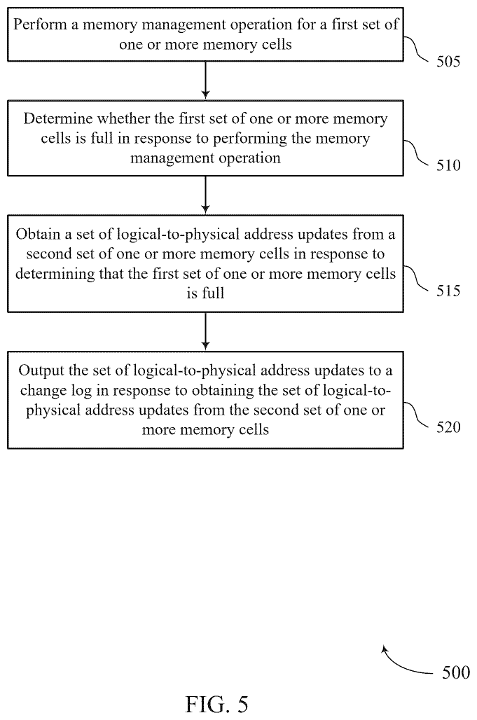

FIG. 5 shows a flowchart illustrating a method 500 that supports delayed memory management operations in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include performing a memory management operation for a first set of one or more memory cells. In some examples, aspects of the operations of 505 may be performed by a memory management component 425 as described with reference to FIG. 4.

At 510, the method may include determining whether the first set of one or more memory cells is full in response to performing the memory management operation. In some examples, aspects of the operations of 510 may be performed by a block capacity component 430 as described with reference to FIG. 4.

At 515, the method may include obtaining a set of logical-to-physical address updates from a second set of one or more memory cells in response to determining that the first set of one or more memory cells is full. In some examples, aspects of the operations of 515 may be performed by a L2P update component 435 as described with reference to FIG. 4.

At 520, the method may include outputting the set of logical-to-physical address updates to a change log in response to obtaining the set of logical-to-physical address updates from the second set of one or more memory cells. In some examples, aspects of the operations of 520 may be performed by an output component 440 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for performing a memory management operation for a first set of one or more memory cells; determining whether the first set of one or more memory cells is full in response to performing the memory management operation; obtaining a set of logical-to-physical address updates from a second set of one or more memory cells in response to determining that the first set of one or more memory cells is full; and outputting the set of logical-to-physical address updates to a change log in response to obtaining the set of logical-to-physical address updates from the second set of one or more memory cells.

Aspect 2: The method, apparatus, or non-transitory computer-readable medium of aspect 1, where the first set of one or more memory cells corresponds to cells having two or more levels and the second set of one or more memory cells corresponds to single-level cells and the method, apparatuses, and non-transitory computer-readable medium further includes operations, features, circuitry, logic, means, or instructions, or any combination thereof for writing, during the memory management operation, one or more logical-to-physical address updates to a buffer; determining whether the buffer is full in response to writing the one or more logical-to-physical address updates; and transferring the one or more logical-to-physical address updates from the buffer to the second set of one or more memory cells in response to determining that the buffer is full.

Aspect 3: The method, apparatus, or non-transitory computer-readable medium of any of aspects 1 through 2, where the first set of one or more memory cells corresponds to cells having two or more levels and the method, apparatuses, and non-transitory computer-readable medium further includes operations, features, circuitry, logic, means, or instructions, or any combination thereof for reading the first set of one or more memory cells in response to determining that the first set of one or more memory cells is full.

Aspect 4: The method, apparatus, or non-transitory computer-readable medium of any of aspects 1 through 3, further including operations, features, circuitry, logic, means, or instructions, or any combination thereof for determining a quantity of valid data associated with the first set of one or more memory cells in accordance with performing the memory management operation; determining a first memory cell type associated with the first set of one or more memory cells and a second memory cell type associated with the second set of one or more memory cells; and adjusting a rate of performing write operations in accordance with the quantity of valid data, the first memory cell type, and the second memory cell type.

Aspect 5: The method, apparatus, or non-transitory computer-readable medium of any of aspects 1 through 4, further including operations, features, circuitry, logic, means, or instructions, or any combination thereof for determining whether the change log is full in response to outputting the set of logical-to-physical address updates to the change log; updating a logical-to-physical address mapping table in response to determining that the change log is full; and clearing the change log in response to updating the logical-to-physical address mapping table.

Aspect 6: The method, apparatus, or non-transitory computer-readable medium of aspect 5, further including operations, features, circuitry, logic, means, or instructions, or any combination thereof for determining whether a workload associated with clearing the change log corresponds to a threshold workload and adjusting a rate of performing write operations in response to determining that the workload satisfies the threshold workload.

Aspect 7: The method, apparatus, or non-transitory computer-readable medium of any of aspects 1 through 6, further including operations, features, circuitry, logic, means, or instructions, or any combination thereof for adjusting a rate of performing write operations in accordance with a workload ratio.

Aspect 8: The method, apparatus, or non-transitory computer-readable medium of any of aspects 1 through 7, where the first set of one or more memory cells and the second set of one or more memory cells corresponds to not-AND (NAND) memory cells and the first set of one or more memory cells corresponds to quad-level cells and the second set of one or more memory cells corresponds to single-level cells.

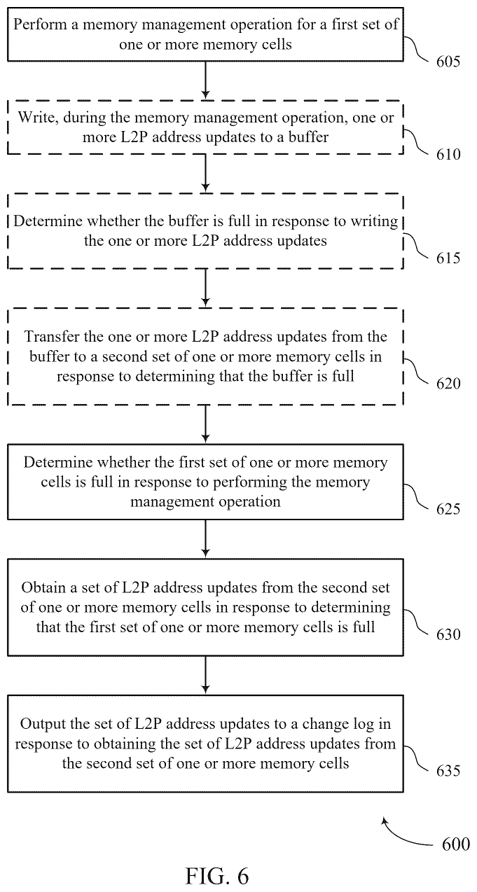

FIG. 6 shows a flowchart illustrating a method 600 that supports delayed memory management operations in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include performing a memory management operation for a first set of one or more memory cells. In some examples, aspects of the operations of 605 may be performed by a memory management component 425 as described with reference to FIG. 4.

At 610, in some examples, the method may include writing, during the memory management operation, one or more L2P address updates to a buffer. In some examples, aspects of the operations of 610 may be performed by a L2P update component 435 as described with reference to FIG. 4.

At 615, in some examples, the method may include determining whether the buffer is full in response to writing the one or more L2P address updates. In some examples, aspects of the operations of 615 may be performed by a buffer capacity component 445 as described with reference to FIG. 4.

At 620, in some examples, the method may include transferring the one or more L2P address updates from the buffer to a second set of one or more memory cells in response to determining that the buffer is full. In some examples, the first set of one or more memory cells may correspond to cells having two or more levels (e.g., QLCs) and the second set of one or more memory cells may correspond to SLCs. In some examples, aspects of the operations of 620 may be performed by a L2P update component 435 as described with reference to FIG. 4.

At 625, the method may include determining whether the first set of one or more memory cells is full in response to performing the memory management operation. In some examples, aspects of the operations of 625 may be performed by a block capacity component 430 as described with reference to FIG. 4.

At 630, the method may include obtaining a set of L2P address updates from the second set of one or more memory cells in response to determining that the first set of one or more memory cells is full. In some examples, aspects of the operations of 630 may be performed by a L2P update component 435 as described with reference to FIG. 4.

At 635, the method may include outputting the set of L2P address updates to a change log in response to obtaining the set of L2P address updates from the second set of one or more memory cells. In some examples, aspects of the operations of 635 may be performed by an output component 440 as described with reference to FIG. 4.

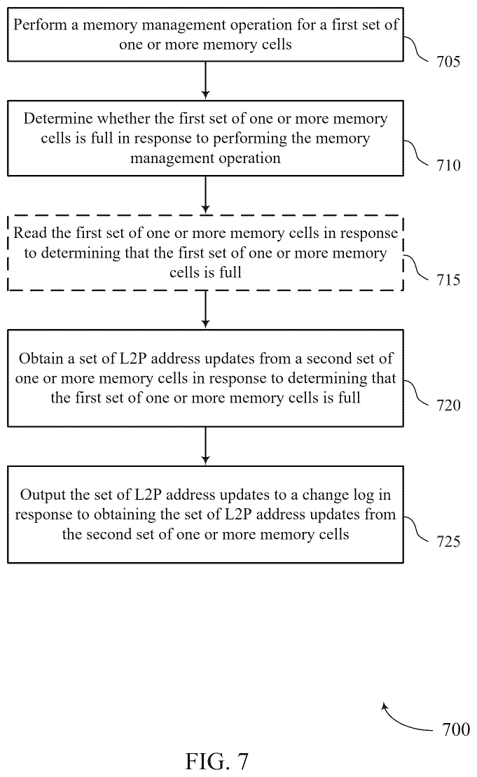

FIG. 7 shows a flowchart illustrating a method 700 that supports delayed memory management operations in accordance with examples as disclosed herein. The operations of method 700 may be implemented by a memory system or its components as described herein. For example, the operations of method 700 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 705, the method may include performing a memory management operation for a first set of one or more memory cells. In some examples, aspects of the operations of 705 may be performed by a memory management component 425 as described with reference to FIG. 4.

At 710, the method may include determining whether the first set of one or more memory cells is full in response to performing the memory management operation. In some examples, aspects of the operations of 710 may be performed by a block capacity component 430 as described with reference to FIG. 4.

At 715, in some examples, the method may include reading the first set of one or more memory cells in response to determining that the first set of one or more memory cells is full. In some examples, aspects of the operations of 715 may be performed by a block reading component 450 as described with reference to FIG. 4.

At 720, the method may include obtaining a set of L2P address updates from a second set of one or more memory cells in response to determining that the first set of one or more memory cells is full. In some examples, the first set of one or more memory cells may corresponds to cells having two or more levels (e.g., QLCs), and the first set of one or more memory cells may include the second set of one or more memory cells (e.g., QLCs). In some examples, aspects of the operations of 720 may be performed by a L2P update component 435 as described with reference to FIG. 4.

At 725, the method may include outputting the set of L2P address updates to a change log in response to obtaining the set of L2P address updates from the second set of one or more memory cells. In some examples, aspects of the operations of 725 may be performed by an output component 440 as described with reference to FIG. 4.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
perform a memory management operation for a first set of one or more memory cells;
determine whether the first set of one or more memory cells is full in response to performing the memory management operation;
obtain a set of logical-to-physical address updates from a second set of one or more memory cells in response to determining that the first set of one or more memory cells is full; and
output the set of logical-to-physical address updates to a change log in response to obtaining the set of logical-to-physical address updates from the second set of one or more memory cells.

2. The memory system of claim 1, wherein the first set of one or more memory cells corresponds to cells having two or more levels and the second set of one or more memory cells corresponds to single-level cells, and the processing circuitry is further configured to cause the memory system to:
write, during the memory management operation, one or more logical-to-physical address updates to a buffer;
determine whether the buffer is full in response to writing the one or more logical-to-physical address updates; and
transfer the one or more logical-to-physical address updates from the buffer to the second set of one or more memory cells in response to determining that the buffer is full.

3. The memory system of claim 1, wherein the first set of one or more memory cells corresponds to cells having two or more levels, and the processing circuitry is further configured to cause the memory system to:
read the first set of one or more memory cells in response to determining that the first set of one or more memory cells is full.

4. The memory system of claim 1, wherein the processing circuitry is further configured to cause the memory system to:
determine a quantity of valid data associated with the first set of one or more memory cells in accordance with performing the memory management operation;
determine a first memory cell type associated with the first set of one or more memory cells and a second memory cell type associated with the second set of one or more memory cells; and
adjust a rate of performing write operations in accordance with the quantity of valid data, the first memory cell type, and the second memory cell type.

5. The memory system of claim 1, wherein the processing circuitry is further configured to cause the memory system to:
determine whether the change log is full in response to outputting the set of logical-to-physical address updates to the change log;
update a logical-to-physical address mapping table in response to determining that the change log is full; and
clear the change log in response to updating the logical-to-physical address mapping table.

6. The memory system of claim 5, wherein the processing circuitry is further configured to cause the memory system to:
determine whether a workload associated with clearing the change log corresponds to a threshold workload; and
adjust a rate of performing write operations in response to determining that the workload satisfies the threshold workload.

7. The memory system of claim 1, wherein the processing circuitry is further configured to cause the memory system to:
adjust a rate of performing write operations in accordance with a workload ratio.

8. The memory system of claim 1, wherein:
the first set of one or more memory cells and the second set of one or more memory cells corresponds to not-AND (NAND) memory cells, and
the first set of one or more memory cells corresponds to quad-level cells and the second set of one or more memory cells corresponds to single-level cells.

9. A non-transitory computer-readable medium storing code comprising instructions which, when executed by one or more processors of a memory system, cause the memory system to:
perform a memory management operation for a first set of one or more memory cells;
determine whether the first set of one or more memory cells is full in response to performing the memory management operation;
obtain a set of logical-to-physical address updates from a second set of one or more memory cells in response to determining that the first set of one or more memory cells is full; and
output the set of logical-to-physical address updates to a change log in response to obtaining the set of logical-to-physical address updates from the second set of one or more memory cells.

10. The non-transitory computer-readable medium of claim 9, wherein the first set of one or more memory cells corresponds to cells having two or more levels and the second set of one or more memory cells corresponds to single-level cells, and the instructions, when executed by the one or more processors of the memory system, further cause the memory system to:
write, during the memory management operation, one or more logical-to-physical address updates to a buffer;
determine whether the buffer is full in response to writing the one or more logical-to-physical address updates; and
transfer the one or more logical-to-physical address updates from the buffer to the second set of one or more memory cells in response to determining that the buffer is full.

11. The non-transitory computer-readable medium of claim 9, wherein the first set of one or more memory cells corresponds to cells having two or more levels, and the instructions, when executed by the one or more processors of the memory system, further cause the memory system to:
read the first set of one or more memory cells in response to determining that the first set of one or more memory cells is full.

12. The non-transitory computer-readable medium of claim 9, wherein the instructions, when executed by the one or more processors of the memory system, further cause the memory system to:
determine a quantity of valid data associated with the first set of one or more memory cells in accordance with performing the memory management operation;
determine a first memory cell type associated with the first set of one or more memory cells and a second memory cell type associated with the second set of one or more memory cells; and
adjust a rate of performing write operations in accordance with the quantity of valid data, the first memory cell type, and the second memory cell type.

13. The non-transitory computer-readable medium of claim 9, wherein the instructions, when executed by the one or more processors of the memory system, further cause the memory system to:
determine whether the change log is full in response to outputting the set of logical-to-physical address updates to the change log;
update a logical-to-physical address mapping table in response to determining that the change log is full; and
clear the change log in response to updating the logical-to-physical address mapping table.

14. The non-transitory computer-readable medium of claim 13, wherein the instructions, when executed by the one or more processors of the memory system, further cause the memory system to:
determine whether a workload associated with clearing the change log corresponds to a threshold workload; and
adjust a rate of performing write operations in response to determining that the workload satisfies the threshold workload.

15. The non-transitory computer-readable medium of claim 9, wherein the instructions, when executed by the one or more processors of the memory system, further cause the memory system to:
adjust a rate of performing write operations in accordance with a workload ratio.

16. The non-transitory computer-readable medium of claim 9, wherein:
the first set of one or more memory cells and the second set of one or more memory cells corresponds to not-AND (NAND) memory cells, and
the first set of one or more memory cells corresponds to quad-level cells and the second set of one or more memory cells corresponds to single-level cells.

17. A method, comprising:
performing a memory management operation for a first set of one or more memory cells;
determining whether the first set of one or more memory cells is full in response to performing the memory management operation;
obtaining a set of logical-to-physical address updates from a second set of one or more memory cells in response to determining that the first set of one or more memory cells is full; and
outputting the set of logical-to-physical address updates to a change log in response to obtaining the set of logical-to-physical address updates from the second set of one or more memory cells.

18. The method of claim 17, wherein the first set of one or more memory cells corresponds to cells having two or more levels and the second set of one or more memory cells corresponds to single-level cells, the method further comprising:
writing, during the memory management operation, one or more logical-to-physical address updates to a buffer;
determining whether the buffer is full in response to writing the one or more logical-to-physical address updates; and
transferring the one or more logical-to-physical address updates from the buffer to the second set of one or more memory cells in response to determining that the buffer is full.

19. The method of claim 17, wherein the first set of one or more memory cells corresponds to cells having two or more levels, and wherein the first set of one or more memory cells comprises the second set of one or more memory cells, the method further comprising:
reading the first set of one or more memory cells in response to determining that the first set of one or more memory cells is full.

20. The method of claim 17, further comprising:
determining a quantity of valid data associated with the first set of one or more memory cells in accordance with performing the memory management operation;
determining a first memory cell type associated with the first set of one or more memory cells and a second memory cell type associated with the second set of one or more memory cells; and
adjusting a rate of performing write operations in accordance with the quantity of valid data, the first memory cell type, and the second memory cell type.

21. The method of claim 17, further comprising:
determining whether the change log is full in response to outputting the set of logical-to-physical address updates to the change log;
updating a logical-to-physical address mapping table in response to determining that the change log is full; and
clearing the change log in response to updating the logical-to-physical address mapping table.

22. The method of claim 21, further comprising:
determining whether a workload associated with clearing the change log corresponds to a threshold workload; and
adjusting a rate of performing write operations in response to determining that the workload satisfies the threshold workload.
